(19) United States
(12) Patent Application Publication
(10) Pub. No.: US 2006/0140274 A1
(43) Pub. Date: Jun. 29, 2006

(54) Transcoder and method used therein

(75) Inventors: Chung-Yen Lu, Taipei City (TW); Shun-Pin Yang, Changhua City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/025,264

(22) Filed: Dec. 29, 2004

(51) Int. Cl. H04N 11/02; H04N 11/04; H04B 1/66; H04N 7/12

(52) U.S. Cl. 375/240.16; 375/240.24; 375/240.2; 375/240.12; 375/240.03

(57) ABSTRACT

A transcoding method and transcoder A compressed bitstream of video data is received and it is determined whether a skipped block occurs in the compressed bitstream. When the skipped block occurs in the compressed bitstream, a corresponding skipped block is generated in a transcoded bitstream without performing error compensation for the skipped block.

### BACKGROUND

The invention relates to a transcoder and method used therein, and in particular, to a transcoder and method for converting the bitrate of a compressed bitstream.

In digital transmission, connection of several transmission media may causes problems. If a program provider transmits, e.g. across a satellite link, a digital video signal in a compressed format to be relayed e.g. on a cable network, the relayed signal must also be in the compressed format. If the bitrate of the digital video signal on the satellite link is R₁ (Mbit/s), and the cable network has a limited capacity, the incoming program can only be relayed if its bitrate is R₂ (Mbit/s) or less. The incoming compressed signal requires conversion to a compressed signal of a lower bitrate, a process referred to as transcoding, performed by a transcoder.

A conventional transcoding operation is shown in FIG. 1. An encoder compresses incoming video signal at a bitrate of R₁ (Mbit/s), and then this compressed signal is converted to a compressed format of a lower bitrate R₂ (Mbit/s). A decoder decompresses the incoming signal and displays the resulting video signal. Transcoding may occur when one means of signal transport interfaces with another means of signal transport. Essentially, a transcoder consists of a cascaded decoder and encoder, as shown in the lower part of FIG. 1.

In MPEG compression, a motion vector can be introduced to shorten a macroblock. Disclosures, such as U.S. Pat. No. 6,775,325 and U.S. Pat. No. 6,081,296, here incorporated as references, utilize auxiliary information such as a motion vector in a macroblock to simplify computational complexity of a transcoder. Further simplification of the computational complexity remains desirable.

### SUMMARY

Embodiments of the invention provide a method for transcoding block-based compressed video data. A compressed bitstream of video data is received to determine whether a skipped block occurs in the compressed bitstream. When there is a skipped block in the compressed bitstream, a corresponding skipped block is generated in a transcoded bitstream.

Further provided is a transcoder receiving a block based, compressed bitstream of video data and outputting a transcoded bitstream, the transcoder comprising a decoder, a controller and an encoder. The decoder comprises an input receiving the compressed bitstream, and decodes the compressed bitstream to provide a block of video data and block information. The controller determines whether a skipped block occurs in the compressed bitstream according to the block information. The encoder uses a compensation block derived from at least a reference error picture to compensate a current decoded block, and encodes a current compensated block into the transcoded bitstream. When a skipped block occurs in the compressed bitstream, the encoder does not use the compensation block to compensate a decoded block corresponding the skipped block.

Also provided is a machine-readable medium storing instructions, which, when executed by a processor, cause the processor to perform: receipt of a compressed bitstream of video data, determination of the presence of an skipped block in the compressed bitstream, determination of whether the skipped block in the compressed bitstream is in a predictive picture, and storage of a compensation block for the skipped block into a corresponding block in a frame buffer without using the compensation block for error compensation when the skipped block is in a predictive picture.

### BRIEF DESCRIPTION OF THE DRAWINGS

The present invention can be more fully understood by reading the subsequent detailed description and examples with references made to the accompanying drawings, wherein:

FIG. 1 shows a conventional transcoding method.

FIG. 2 shows a macroblock coded according to MPEG convention.

FIGS. 3, 4 and 5 show operations of three transcoders in embodiments of the invention.

FIGS. 6a and 6b show the outlines of two transcoders in embodiments of the invention.

FIGS. 7, 8a and 8b are flowcharts of two methods for transcoding a macroblock in embodiments of the invention.

FIG. 9 shows a machine in embodiments of the invention.

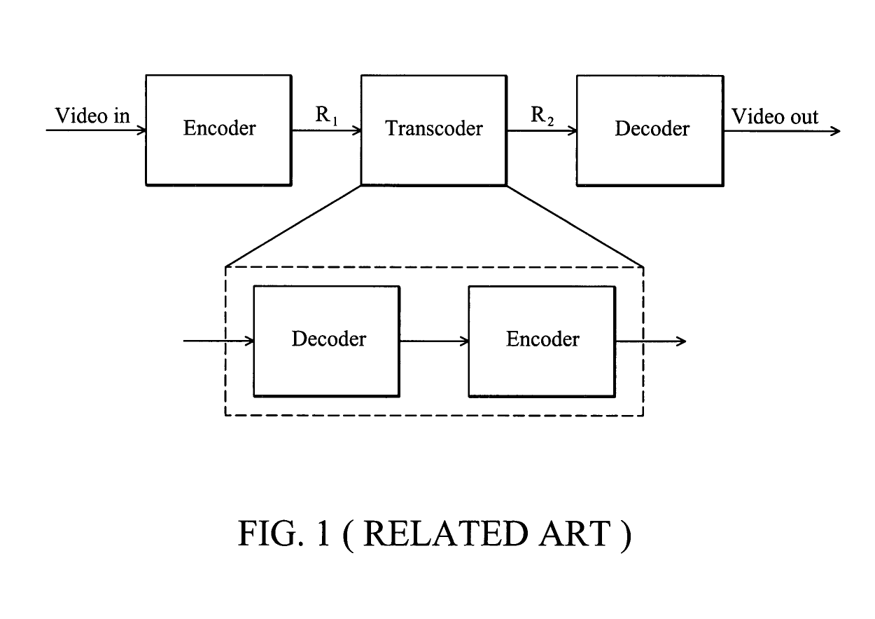

### DETAILED DESCRIPTION

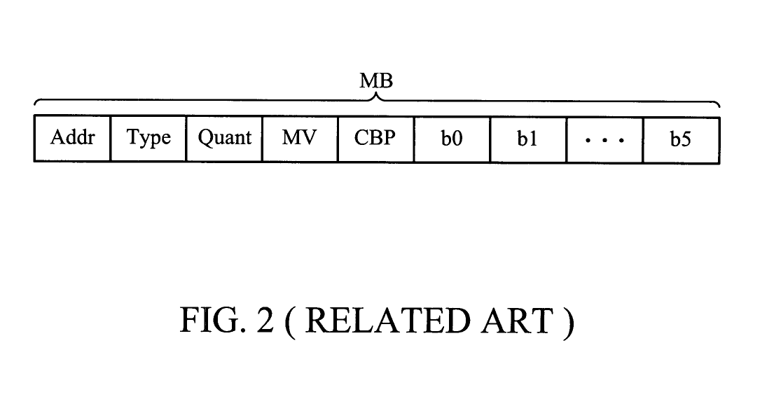

FIG. 2 shows a macroblock coded according to MPEG convention. “Addr” and “Type” respectively denote the address and type of a macroblock. “Quant” denotes the scale used to quantize the DCT coefficients of the macroblock. “MV” denotes the motion vector of the macroblock, representing a displacement of a macroblock in a reference picture. “CBP” is Coded Block Pattern, having six bits, each indicating whether a corresponding block in the macroblock has a good match in the reference picture. “b0” to “b5” are encoded blocks, four for luminance (Y) and two for chrominance (Cb and Cr). CBP[k] with a value “0” means that DCT coefficients of block k are all zero and block k is skipped in the macroblock. Hereinafter MB_{addr} denotes the macroblock whose address is “addr.”

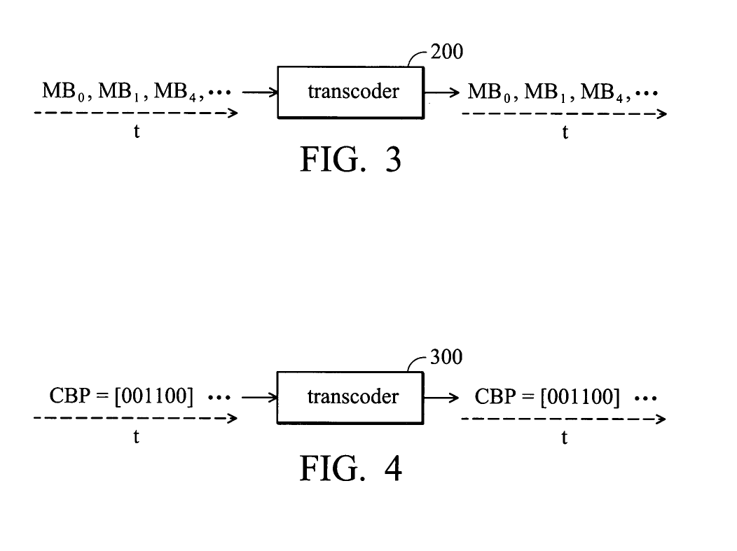

FIG. 3 shows the operation of a transcoder in embodiments of the invention, transcoding incoming bitstreams with a first quantization scale into an output bitstream with a second quantization scale larger than the first quantization scale. The larger the quantization scale the lower the bit-rate. When a skipped macroblock occurs in the incoming compressed bitstream, the transcoder 200 generates a corresponding skipped macroblock in the outgoing transcoded bitstream. In FIG. 3, MB₀, MB₁, and MB₄ are transmitted in sequence in an incoming bitstream. MB₀ and MB₁ are transcoded and output in sequence. After decoding MB₄, due to address discontinuity, the transcoder 200 determines that MB₂ and MB₃ are skipped to encode in the incoming bitstream, and, accordingly, outputs not MB₂ and MB₃, but rather MB₄, thereby generating two skipped macroblocks MB₂ and MB₃ in its output bitstream. As shown in FIG. 3, the transcoded bitstream has an output sequence without MB₂ and MB₃, both skipped in the incoming bitstream.

The same skipping concept is applicable not only to a skipped macroblock but also to a skipped block in an un-skipped macroblock. FIG. 4 shows another transcoder in certain embodiments of the present invention. When a skipped block occurs in the incoming bitstream, the transcoder 300 generates a corresponding skipped block in the transcoded bitstream. In FIG. 4, a CBP in an un-skipped macroblock is [001100], whereby blocks 0, 1, 4, and 5 in the un-skipped macroblock are skipped in the incoming bitstream. After downloading the CBP and determining its content, the transcoder 300 notes that blocks 0,1, 4, and 5 are skipped for encoding in the incoming bitstream, and, accordingly, creates the same CBP of [001100] for a macroblock in its transcoded bitstream, thereby generating skipped blocks 0, 1, 4, and 5 therein.

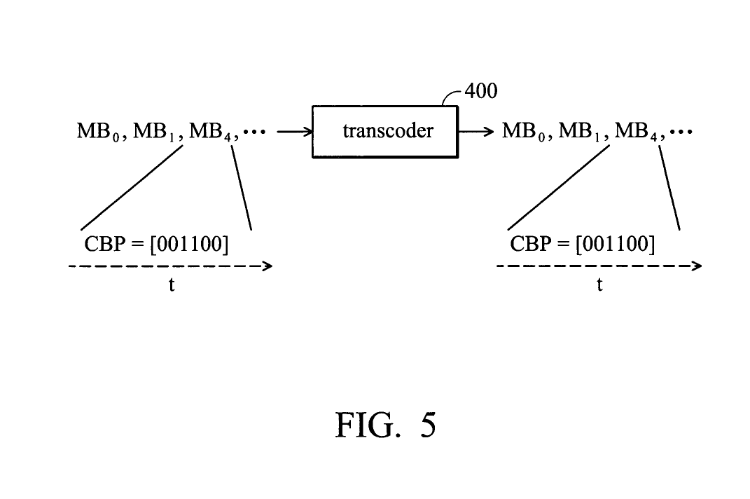

FIG. 5 shows a transcoder performing according to parameters for transcoders in both FIGS. 3 and 4. When a skipped macroblock or block occurs in the incoming bitstream, the transcoder 400 generates a corresponding skipped macroblock or block in its transcoded bitstream. As shown in FIG. 5, MB₂ and MB₃ are skipped in the transcoded bitstream as being skipped in the incoming bitstream, and the CBP of MB₄ in the incoming bitstream is the same as that of MB₄ in the transcoded bitstream.

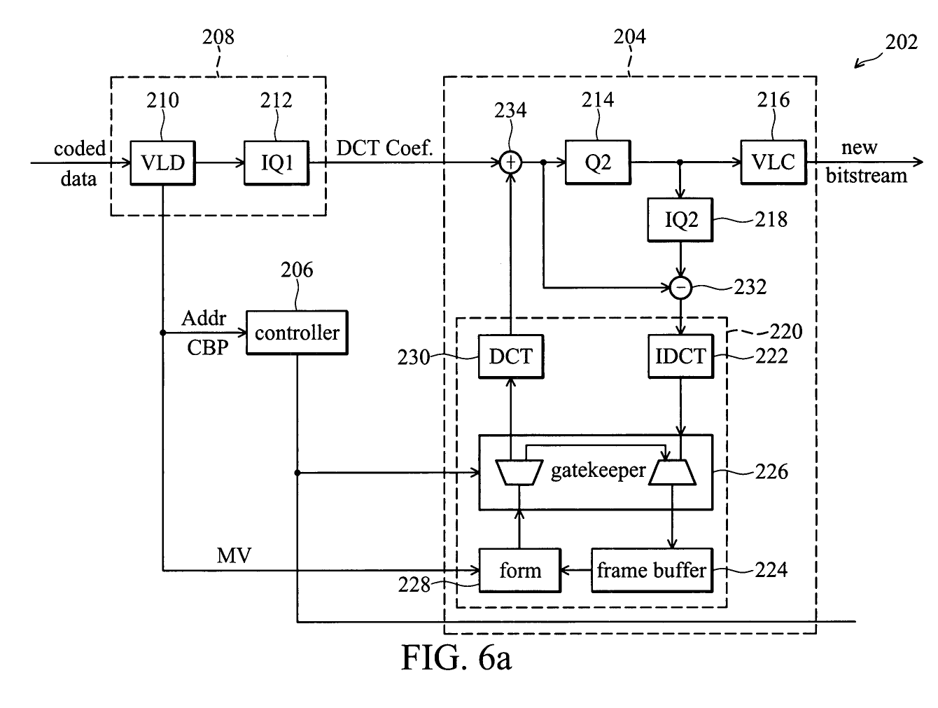

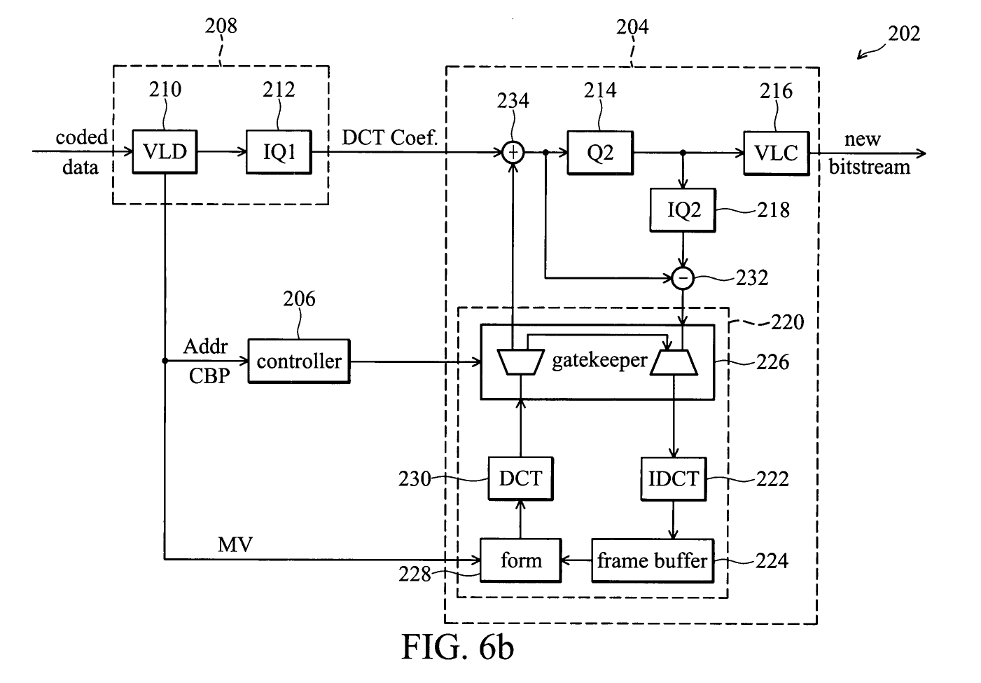

FIG. 6a shows an outline of a transcoder 202 in embodiments of the invention. Note that only the prediction loop of the transcoder 202 is shown.

The transcoder 202 comprises a cascaded decoder 208 and encoder 204, and a controller 206. Varied length decoder (VLD) 210 decodes the incoming, coded bitstream to yield the value of the quantized coefficients, and these quantized coefficients are de-quantized by inverse-quantizer (IQ1) 212 to generate discrete cosine transform (DCT) coefficients. If a current decoded block is intra type, that is the current decoded block is encoded using information from itself, DCT coefficients generated by decoder 208 are directly received by re-quantization module (Q2) 214 and varied length encoder (VLC) 216 where the DCT coefficients of the current decoded block are re-quantized and encoded. The re-quantized DCT coefficients may be also received by an inverse-quantization module (IQ2) 218. Subtractor 232 generates an error block representing the re-quantization error of the DCT coefficients due to the cascaded re-quantization and inverse-quantization, and this error block can be then stored into error compensation module 220. Error compensation module 220 may generate a compensation block to compensate through a summation unit 234 a current decoded block if the current decoded block is a predicted block referencing another picture.

IDCT applied by Inverse DCT (IDCT) module 222 converts the error block from a frequency domain to a spatial domain and the IDCT error block can be stored into the frame buffer 224. In summary, frame buffer 224 stores a reference error picture which represents the re-quantization error of a re-encoded precedent picture. Form module 228 utilizes the motion vector of a current decoded macroblock and a reference error picture associated with a received, reference picture to generate a compensation block in a spatial domain. For consistency, “reference picture” represents I or P frames while “predictive picture” represents P or B frames throughout the specification. DCT may be applied to the compensation block to generate its DCT coefficients which compensate the DCT coefficients of a current decoded block from the decoder 208. Prediction error drift, in which error occurring in encoding a current picture is propagated to a predictive picture which references the encoded current picture, is thus suppressed.

Controller 206 receives the address or CBP of the current decoded macroblock to determine if there is a skipped macroblock or block in the incoming bitstream. If found, controller 206 enforces VLC module 216 to generate a corresponding skipped macroblock or block. If some certain other conditions, discussed later, are met, gatekeeper 226 does not feed the compensation block from form module 228 to DCT module 230, but directly stores it in a corresponding block of frame buffer 224 as an IDCT error block. The compensation block therefore does not flow through the path of DCT module 230, Q2 module 214, IQ2 module 218 and IDCT module 222. All the computations along this path are circumvented and transcoder 202 is sped.

For example, if a current decoded macroblock is determined by controller 206 to have a skipped block inside and is in a P picture, VLC module 216 generates a corresponding skipped block in its output bitstream by outputting a corresponding macroblock with a CBP the same as that of the current decoded macroblock. DCT coefficients of the skipped block, all zero, appear as if re-quantized and encoded without performing error compensation for the quantization error generated by encoding a received, reference picture. This quantization error should not be discarded, since the P picture to which skipped block belongs may be referenced by a succeeding picture, otherwise prediction error drift occurs. Therefore, gatekeeper 226 directly feeds the compensation block generated from form module 228 to frame buffer 224 for storage, thereby suppressing prediction error drift.

FIG. 6b shows the outline of another transcoder according to embodiments of the invention, in which gatekeeper is re-located. In FIG. 6b, gatekeeper 226 is between DCT 230 and summation unit 234 and between subtractor 232 and IDCT module 222. Gatekeeper 226 can directly pass the DCT coefficients of a compensation block to summation unit 234, and an error block to IDCT module 222. Alternatively, gatekeeper 226 can directly feed the DCT coefficients of a compensation block from DCT module 230 into IDCT module 222, thereby storing a DCT and IDCT converted compensation block in frame buffer 224.

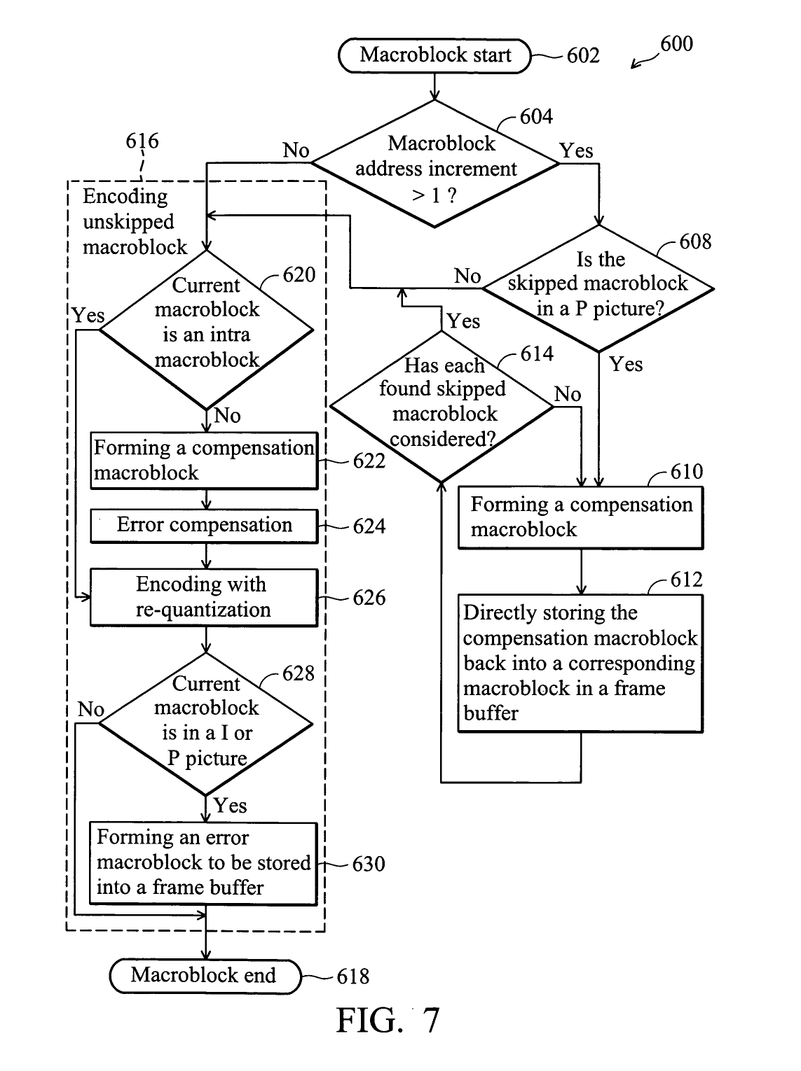

FIG. 7 is a flowchart of a method 600 for transcoding a macroblock according to embodiments of the invention. Commencing at step 602 and proceeding to step 604, in which after decoding a current macroblock, the address of the current macroblock is retrieved to determine if coding of a preceding macroblock has been skipped. If so, for example, if the address of the current macroblock is not adjacent to that of the macroblock most recently decoded or macroblock address increment is more than 1, at least one skipped macroblock occurs in the incoming bitstream and the method proceeds to step 608. In step 608, method 600 determines if the skipped macroblock is in a P picture.

If so, ignored error compensation should be stored and the method proceeds to step 610. If not, the ignored error compensation can be discarded and the method proceeds to step 616.

In step 610, a compensation macroblock corresponding to one skipped macroblock is generated, and the method proceeds to step 612, in which the compensation macroblock is not used for current compensation but directly stored back into a corresponding macroblock in a frame buffer, and the method proceeds to step 614, determining if each located skipped macroblock has been considered. If there located any skipped macroblock has not yet been checked, the method returns to step 610, generating another compensation macroblock corresponding to each un-checked skipped macroblock. If the query in step 614 is confirmed, the method proceeds to step 616.

In step 616, the current macroblock is encoded, and only one corresponding transcoded macroblock is output in its output transcoded bitstream. Step 620 determines whether the current macroblock is an intra macroblock. If so, the current macroblock references nothing and is encoded with re-quantization in step 626. If not, in order to suppress prediction error drift, the motion vector of the current macroblock is utilized to retrieve and form a compensation macroblock from a frame buffer in step 622. Following step 622, step 624 uses the compensation macroblock to compensate the current macroblock and proceeds to step 626, encoding with re-quantization. Step 628 follows step 626 to determine whether the current macroblock is in a reference picture. If so, quantization error should be recorded and therefore step 630 forms an error macroblock stored in a frame buffer. If not, re-quantization error can be discarded and the method 600 concludes with step 618. Skipped macroblocks in the incoming bitstream are not encoded, resulting in corresponding skipped macroblocks in the transcoded bitstream.

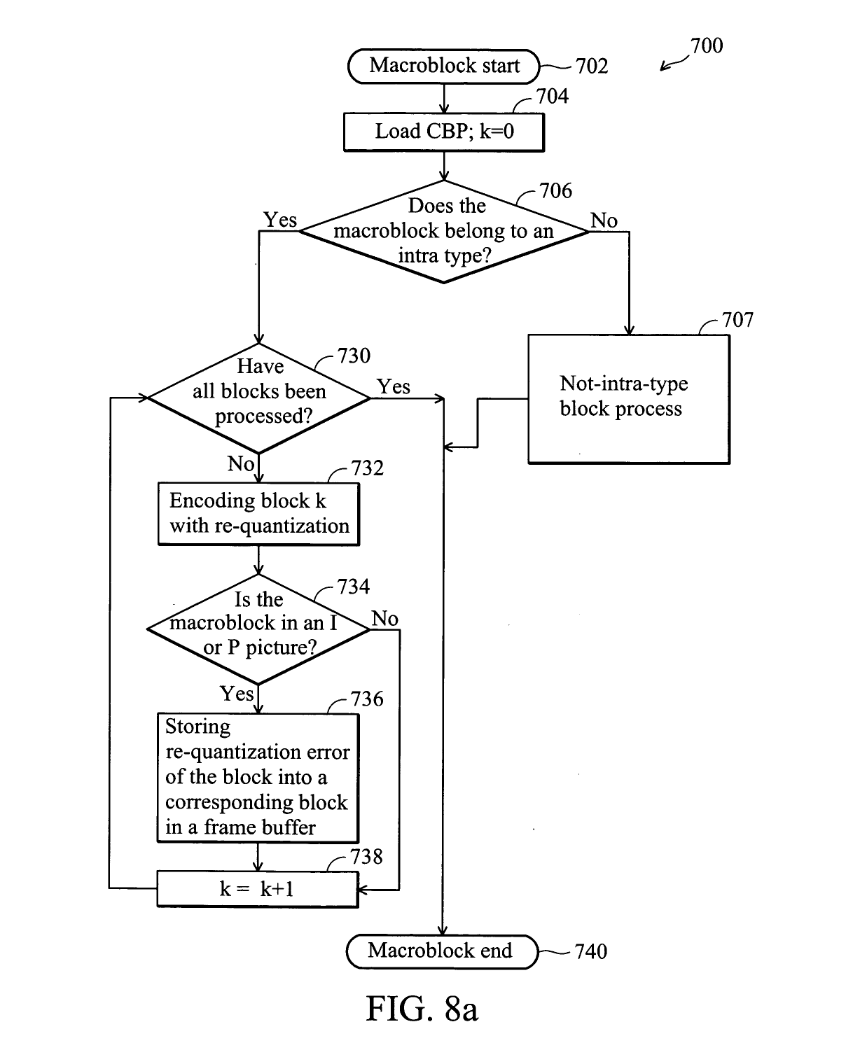

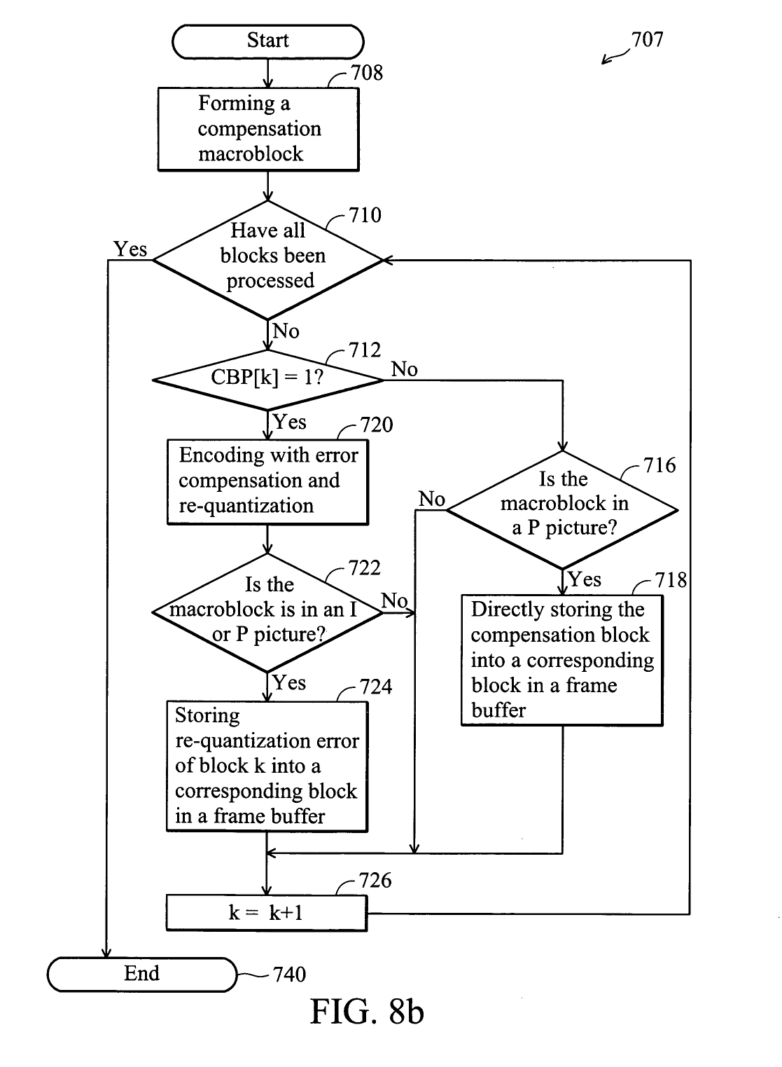

FIGS. 8a and 8b is a flowchart of a method 700 for transcoding a macroblock according to embodiments of the invention. Commencing in step 702 and continuing to step 704, where, after decoding a current macroblock, the CBP of the current macroblock is loaded and variable k is set as 0. The instant value of k is the series number of a block under consideration. In step 706, it is determined whether the current macroblock belongs to an intra type. If so, the method proceeds to step 730. If not, the method proceeds to step 707, not-intra-type process, detailed later in FIG. 8b.

In step 730, it is determined whether all blocks in the current macroblock have been processed. If so, the method concludes with step 740. If not, the method proceeds to step 732. For brevity, hereinafter block k denotes the block with series number k. In step 732, block k is encoded with re-quantization, proceeding to step 734, in which, it is determined whether the current macroblock is in an I or P picture, and, if so, a re-quantization error of the current macroblock is to be stored in following step 736 in a corresponding block in a frame buffer, followed by step 738, in which k is increased by 1 to advance to the next block. If not, the current macroblock is not to be referenced in the future and its re-quantization error can be discarded, such that the method proceeds directly to step 738. After step 738, method returns back to step 730.

As step 707 commencing in step 708, a compensation macroblock is formed and the method proceeds to step 710, in which it is determined whether all blocks in the current macroblock have been processed. If so, the method 700 concludes with step 740. If not, the method proceeds to step 712, in which it is determined whether block k is a skipped block in the current macroblock, by checking CBP[k], the kth bit of CBP, either 0 or 1, to respectively associate with a skipped or un-skipped block k.

If CBP[k] is found to be 1, the method proceeds to step 720, in which block k in encoded with error compensation and re-quantization. In step 722, it is determined whether the current macroblock is in an I or P picture. If so, the method proceeds to step 724, and stores re-quantization error of block k into a corresponding block in a frame buffer, followed by step 726.

If CBP[k] is found to be 0 in step 712, the method proceeds to step 716, determining whether the macroblock is in a P picture. If not, step 726 follows. If so, the method proceeds to step 718, in which a compensation block generated for compensating block k is directly stored back into a corresponding block in a frame buffer, rather than used to compensate block k. Following is step 726, in which k is increased by 1 to advance to the next block. The method returns to step 710 after step 726, thus, skipped blocks in a decoded macroblock are not encoded and generate skipped blocks in a transcoded bitstream.

Method 600 in FIG. 7 generates a corresponding skipped macroblock in a transcoded bitstream when a skipped macroblcok occurs in an incoming bitstream. Method 700 in FIGS. 8a and 8b generates a corresponding skipped block in a transcoded bitstream when a skipped block occurs in an incoming bitstream. Methods 600 and 700 do not exclude each other, and are individually or collaboratively workable. Method 700 can collaborate with method 600 by using method 700 to perform step 616 of method 600.

According to embodiments of the invention, it may be unnecessary to perform error compensation and re-quantization for skipped blocks or macroblocks in incoming bitstreams, such that, computational complexity may be reduced. Furthermore, for a skipped block or macroblock in a P picture, compensation blocks originally generated for error compensation are stored directly into a frame buffer, potentially circumventing computations such as re-quantization, error compensation, de-quantization, DCT, and IDCT. Embodiments of the invention may reduce computation complexity for skipped blocks or macroblocks, possibly shortening transcoding time.

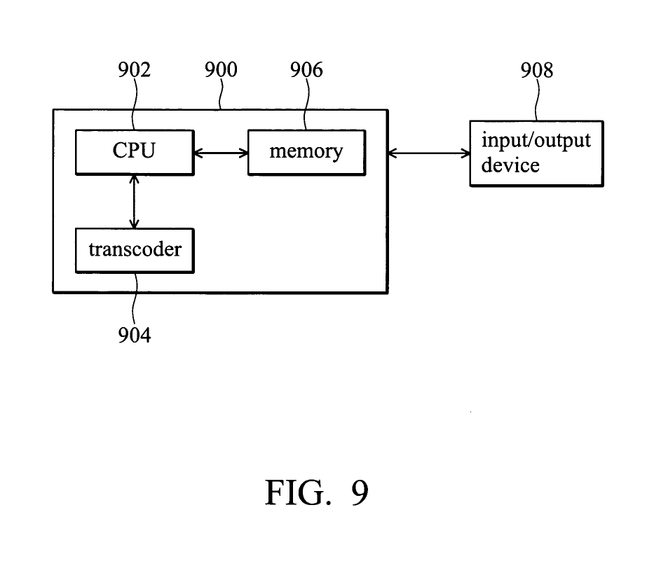

FIG. 9 shows a machine 900 according to embodiments of the invention, comprising a central processing unit (CPU) 902, a memory 906 and a transcoder 904. Machine 906 can be coupled to a plurality of input and output devices 908, such as a keyboard, a camera, a camcorder, a video monitor, any number of imaging devices or storage devices.

Transcoder 904 performing method 700 or 600 as shown in FIG. 7 or 8, may be a physical device coupled to CPU 902 through a communication channel. Alternatively, the transcoder 904 can be embodied in a software application (or combination of software and hardware, e.g. application specific integrated circuits (ASIC)) loaded from a storage device and resides in memory 906 of the machine. As such, transcoder 904 can be stored on a machine-readable medium, e.g., a memory or storage device. An incoming bitstream before transcoded may be received from the input and output devices 908 and/or stored in the memory 906. A correspondingly generated transcoded bitstream may be stored into the memory 906 and/or output to the input and output devices 908.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for transcoding a block based, compressed bitstream of video data, comprising:
receiving the compressed bitstream of video data;
determining if a skipped block occurs in the compressed bitstream; and
generating a corresponding skipped block in a transcoded bitstream when a skipped block occurs in the compressed bitstream.

2. The method as claimed in claim 1, wherein the skipped block is a skipped macroblock.

3. The method as claimed in claim 1, further comprising:
determining whether the skipped block in the compressed bitstream is in a predictive picture; and
storing a compensation block for the skipped block into a corresponding block in a frame buffer when the skipped block is in a predictive picture.

4. The method as claimed in claim 3, wherein the compensation block is stored without sequentially re-quantizing and inverse-quantizing the compensation block.

5. The method as claimed in claim 3, wherein the compensation block is stored without sequential DCT and inverse DCT transformation of the compensation block.

6. A transcoder for receiving a block based, compressed bitstream of video data and outputting a transcoded bitstream, the transcoder comprising:
a decoder comprising an input to receive the compressed bitstream, decoding the compressed bitstream to provide a block of video data and block information;
a controller determining whether a skipped block occurs in the compressed bitstream according to the block information; and
an encoder using a compensation block derived from at least a reference error picture to compensate a current decoded block, and encoding a current compensated block into the transcoded bitstream;
wherein when a skipped block occurs in the compressed bitstream, the encoder does not use the compensation block to compensate a decoded block corresponding to the skipped block.

7. The transcoder as claimed in claim 6, wherein the block information comprises a motion vector, and the encoder comprises:
a re-quantizer re-quantizing DCT coefficients of the current decoded block;
a quantization error estimator generating an error block associated with the quantization error of the current decoded block in the encoder; and
an error compensator using the motion vector of the current decoded block to generate the compensation block contingent upon a block type and storing the error block of the current decoded block contingent upon a picture type.

8. The transcoder as claimed in claim 7, wherein the encoder further comprises a summation unit using the compensation block to compensate the current decoded block, and the error compensator comprises a gatekeeper coupled to the summation unit, suspending delivery of the compensation block to the summation unit when the current decoded block is a skipped block in the compressed bitstream.

9. The transcoder as claimed in claim 8, wherein when the current decoded block is in a predictive picture and is a skipped block in the compressed bitstream, the gatekeeper further stores the compensation block as an error block.

10. The transcoder as claimed in claim 9, wherein the error compensator comprises:
an inverse DCT operator generating an IDCT error block associated with the error block; and
a frame buffer storing a reference error picture comprising the IDCT error block of the current decoded block; and
a form module generating a spatial compensation block according to the motion vector and the reference error picture; and
a DCT module converting the spatial compensation block to the compensation block.

11. The transcoder as claimed in claim 7, wherein the error compensator comprises:
an inverse DCT operator generating an IDCT error block associated with the error block; and
a frame buffer storing a reference error picture comprising the IDCT error block of the current decoded block;
a form module generating a spatial compensation block according to the motion vector and the reference error picture;
a DCT module converting the spatial compensation block into the compensation block; and
a gatekeeper coupled between the DCT module and the form module, suspending delivery of the spatial compensation block to the DCT operator when the current decoded block is a skipped block in the compressed bitstream.

12. The transcoder as claimed in claim 11, wherein when the current decoded block is in a predictive picture and is a skipped block in the compressed bitstream, the gatekeeper further provides the spatial compensation block to the frame buffer to be stored as an IDCT error block.

13. A transcoder receiving a block based, compressed bitstream of video data and outputting a transcoded bitstream, the transcoder comprising:
a decoder comprising an input to receive the compressed bitstream, decoding the compressed bitstream to provide a block of video data and block information;
a controller determining whether an skipped block occurs in the compressed bitstream according to the block information; and
an encoder encoding the block of video data into the transcoded bitstream;
wherein when the controller determines a skipped block occurring in the compressed bitstream, the encoder generates a corresponding skipped block in the transcoded bitstream.

14. The transcoder as claimed in claim 13, wherein the encoder uses a compensation block associated with a reference picture to compensate a current decoded block, encodes a current compensated block into the transcoded bitstream, and when a skipped block occurs in the compressed bitstream, does not compensate a corresponding decoded block.

15. A machine-readable medium storing code, which, when executed by a processor, causes the processor to perform the steps of:
receiving a compressed bitstream of video data;
determining whether an skipped block occurs in the compressed bitstream; and
storing a compensation block for the skipped block into a corresponding block in a frame buffer without using the compensation block for error compensation when a predetermined condition is met.

16. The machine-readable medium as claimed in claim 15, wherein the steps further comprise a step of determining whether the skipped block in the compressed bitstream is in a predictive picture.

17. The machine-readable medium as claimed in claim 16, wherein the predetermined condition is that an skipped block occurs in the compressed bitstream and the skipped block is in a predictive picture.

18. The machine-readable medium as claimed in claim 17, wherein the compensation block is stored without sequentially re-quantizing and inverse-quantizing the compensation block when the skipped block is in a predictive picture.

19. The machine-readable medium as claimed in claim 15, wherein the compensation block is stored without sequential DCT and inverse DCT transformation of the compensation block when the skipped block is in a predictive picture.

20. The machine-readable medium as claimed in claim 15, wherein the steps further comprise a step of generating in a transcoded bitstream a corresponding skipped block when the predetermined condition is met.
